(19) United States
(12) Patent Application Publication
(10) Pub. No.: US 2011/0227934 A1
(43) Pub. Date: Sep. 22, 2011

(54) Architecture for Volume Rendering

(75) Inventor: Toby Sharp, Cambridge (GB)

(73) Assignee: Microsoft Corporation, Redmond, WA (US)

(21) Appl. No.: 12/727,849

(22) Filed: Mar. 19, 2010

(51) Int. Cl. G06F 15/16

(52) U.S. Cl. 345/502

(57) ABSTRACT

Architecture for volume rendering is described. In an embodiment volume rendering is carried out at a data centre having a cluster of rendering servers connected using a high bandwidth connection to a database of medical volumes. For example, each rendering server has multiple graphics processing units each with a dedicated device thread. For example, a surgeon working from home on her netbook or thin client is able to have a medical volume rendered remotely at one of the rendering servers and the resulting 2D image sent to her over a relatively low bandwidth connection. In an example a master rendering server carries out load balancing at the cluster. In an example each rendering server uses a dedicated device thread for each graphics processing unit in its control and has multiple calling threads which are able to send rendering instructions to appropriate ones of the device threads.

### BACKGROUND

Volume data, such as multi-dimensional images, need to be rendered onto 2D displays in many situations such as for medical imaging, mechanical engineering, scientific visualization, computer games and other applications. For example, volume rendering algorithms take an input signal defined on a three-dimensional domain and project it onto a two-dimensional image.

Various techniques are known for rendering 3D and higher dimensional images onto 2D displays. For example ray casting involves tracing the path of light through pixels in an image plane into a 3D volume. The 3D volume may have been obtained empirically using measurement equipment such as an MRI scanner or image capture device. However, ray casting is extremely computationally expensive and time consuming as it involves integrating data at each point along each ray. This has meant that many practical applications that use ray casting have typically rendered images slowly ahead of time. Also, typically only the surfaces of objects in the volume have been rendered in order to cut down on the amount of computation required. In the case of medical imaging applications this has led to omission of context providing detail in the resulting 2D images and this makes it harder for medical staff to understand and interpret the rendered images.

In hospitals, computerized tomography (CT) scanners, magnetic resonance imaging (MRI) scanners and other equipment produce new volume data for patients every day. Currently this volume data can only be visualized on dedicated workstations or rendered remotely by expensive CPU clusters. This makes it difficult for medical staff to view diagnostic quality renderings of the volume data quickly over low bandwidth connections and/or using thin clients. It is also difficult for medical staff to be given ubiquitous access to high quality renderings of volume data from different locations on a network and simultaneously with access by other medical staff. These problems also exist for other types of volume data that is required to be visualized on-demand and in real-time by multiple simultaneous users, with low latency even on low bandwidth internet connections and on thin clients.

The embodiments described below are not limited to implementations which solve any or all of the disadvantages of known volume rendering systems.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Architecture for volume rendering is described. In an embodiment volume rendering is carried out at a data centre having a cluster of rendering servers connected using a high bandwidth connection to a database of medical volumes. For example, each rendering server has multiple graphics processing units each with a dedicated device thread. For example, a surgeon working from home on her netbook or thin client is able to have a medical volume rendered remotely at one of the rendering servers and the resulting 2D image sent to her over a relatively low bandwidth connection. In an example a master rendering server carries out load balancing at the cluster. In an example each rendering server uses a dedicated device thread for each graphics processing unit in its control and has multiple calling threads which are able to send rendering instructions to appropriate ones of the device threads.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a volume rendering system;

FIG. 2 is a flow diagram of rendering server selection;

FIG. 3 is a flow diagram of device threads on a rendering server;

FIG. 4 is a flow diagram of interaction between a calling thread and a device thread;

FIG. 5 is a flow diagram of interaction between a plurality of calling threads and a plurality of device threads;

FIG. 6 is a flow diagram of multiple job processing;

FIG. 7 illustrates an exemplary computing-based device in which embodiments of a volume rendering architecture may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a volume rendering system, the system described is provided as an example and not a limitation. As those skilled in the art will appreciate, the present examples are suitable for application in a variety of different types of rendering systems.

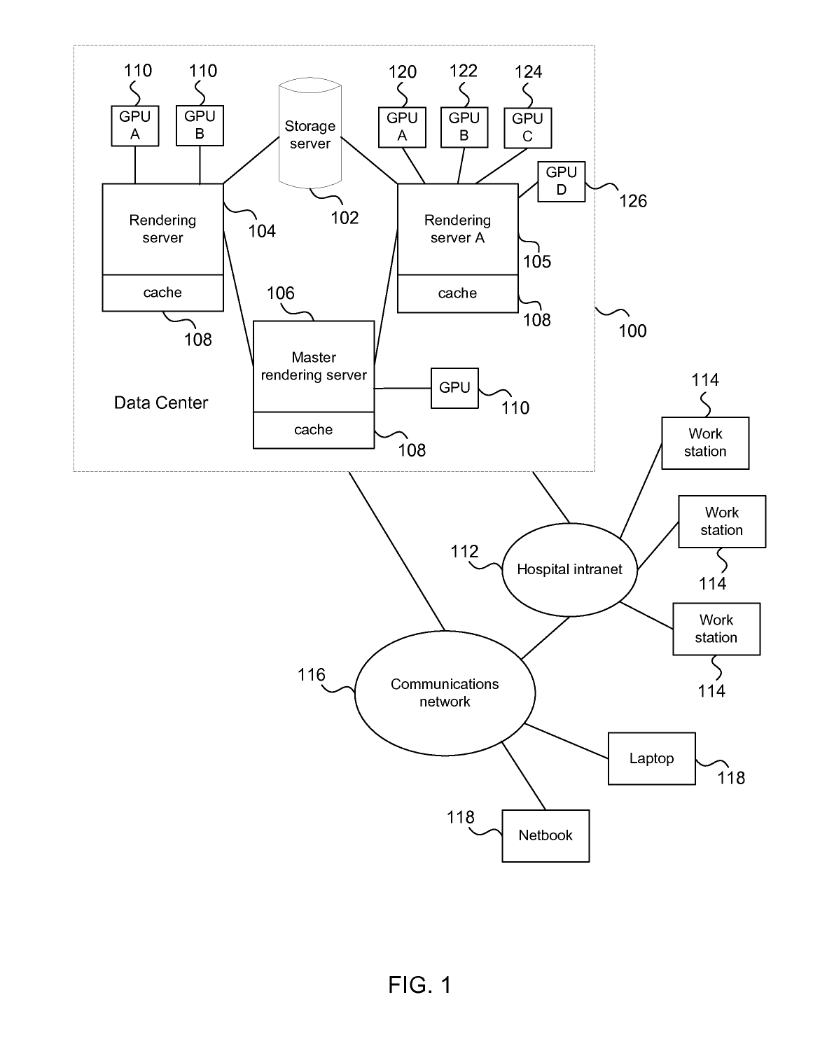

FIG. 1 is a schematic diagram of a volume rendering system. A data centre 100 comprises at least one storage server 102, a plurality of rendering servers 104, 105 and at least one master rendering server 106. Herein the term “server” is used to refer to any combination of hardware and/or software designed to provide services to clients. Volume data such as 3-dimensional data sets or higher dimensional data sets are stored on a storage server 102. A non-exhaustive list of examples of multi-dimensional image data is: 3D medical image data, magnetic resonance imaging (MRI) data, computed tomography (CT) data, single photon emission computed tomography (SPECT) data, positron emission tomography (PET) data, DTI tractography data and ultrasound scan data. Other non-medical applications, such as radar or microscopy can also generate multi-dimensional data.

The storage server (102) comprises any appropriate storage media. Examples of appropriate storage media are magnetic or optical storage devices, random access memory (RAM), a hard disk drive, CD, DVD or other disc drive, flash memory, EPROM or EEPROM. The storage server may be located at the same machine as the master rendering server 106 or other rendering servers 104, 105. Alternatively the rendering and storage servers can be located on separate machines with a high bandwidth connection provided between each rendering server 102, 104, 105, 106 and the storage server 102.

Each of the rendering servers has at least one cache 108 in which volume data sets retrieved from the storage server 102 can be stored. Each rendering server may have a plurality of caches. One or more Graphics Processing Units (GPUs) 110, 120, 122, 124, 126 are integral with or connected to each rendering server and under the control of that rendering server. A GPU is a specialized processor that offloads three dimensional graphics rendering from a microprocessor. Whereas CPUs typically have a few cores (2-8 for example) GPUs often have hundreds or more and so are more suited to finer grained parallel tasks like ray casting. This may offer large performance benefits for graphics rendering as well as other complex algorithms where the algorithms are appropriately designed to make benefit of the GPU resources.

Images are rendered at the data centre from the volume data stored at the storage server 102 using any suitable rendering algorithm. Examples of suitable rendering algorithms include but are not limited to ray-casting and marching cubes. The images rendered at the data centre 100 can then be served to remote client machines. The images may be served over a hospital intranet 112 or through a communications network 116. The communications network may be any appropriate network. Examples of appropriate networks are Local Area Networks (LAN), Wide Area Networks (WAN), Public Switched Telephone Networks (PSTN), the Internet and Virtual Private Networks (VPN). The network 116 can be a wireless network or a wired network or combinations of these.

The files may be transferred using any appropriate file transfer protocol. A non-exhaustive list of examples of appropriate file transfer protocols is HTTP, FTP, SFTP, SCP. The files are transferred to a remote client. In the examples described herein remote clients include hospital work stations 114, laptops or netbooks 118. The rendered images may be optionally displayed at the remote client or on any appropriate display.

Volume data sets are large in size and transferring such data sets to client machines 114, 118 over networks which may have low-bandwidth causes delays in interaction with the data sets. In addition, parts of the data may be lost or become corrupted during the transfer process. Volume rendering is also highly computationally and memory intensive and imposes cumbersome restrictions on client machines 114, 118 in terms of their CPUs and GPUs. A relatively low specification client machine such as netbook 118 may lack the resources to execute appropriate rendering algorithms, which may leave the user unable to view the data remotely. By using clusters of GPUs at a data center as described herein these issues are addressed. For example, this enables hospital-scale deployment of remote rendering of medical volume data. In addition, by concentrating the required computing power in a data centre 100 it may also be possible to leverage efficiencies and economies of scale such as by reducing installation costs.

Using clusters of GPUs yields challenges related to simultaneous clients, load balancing, transport and efficiency. For example, simultaneous volume rendering is carried out at the data centre for a plurality of data sets and served to client machines 114, 118 at remote locations. Users of client machines can include radiologists, surgeons, oncologists, general practitioners, patients or any other appropriate user. To most efficiently make use of the available resources load balancing is performed among the multiple processors to achieve scaleability and serve many different clients simultaneously. Load balancing techniques can be used to select an appropriate GPU. In the examples herein the rendering server can be selected by looking for the GPU with the most free memory and returning its host's address to the client. However, any appropriate load balancing mechanism can be used. Examples of load balancing mechanisms are round robin or random choice algorithms. Other factors may be taken into account when selecting which GPU to use. A non-exhaustive list of factors is; a server's reported load, recent response times, up/down status (determined by a monitoring poll of some kind), number of active connections, geographic location, capabilities, or how much traffic a rendering server has recently been assigned. Multiple layers of load balancing may be used. For example, load balancing between master rendering servers (in cases where two or more master rendering servers are provided), load balancing between rendering servers associated with a particular master rendering server, load balancing between GPUs associated with a particular rendering server.

In the examples described herein volume rendering may be carried out by graphics processing units of which there is at least one integral with or connected to each rendering server. GPUs 110,120, 122,124,126 may provide efficient volume rendering due to their parallelism, their built in tri-linear texture sampling and their superior memory bandwidth (as compared with CPUs).

Client side software is optionally provided on the client machines 114, 118 to enable an end user to request and view images rendered at the data centre 100. In an example the client side software is a thin client which may provide a graphical user interface to a rendering service provided by the data center 100. In an example the thin client provides the ability to control the rendering service to load volume data sets from the storage server 102 to a GPU at the data center 100, to choose a rendering mode, to interactively manipulate a viewpoint and transfer functions; and to define and interactively manipulate clipping planes or carry out any other appropriate task.

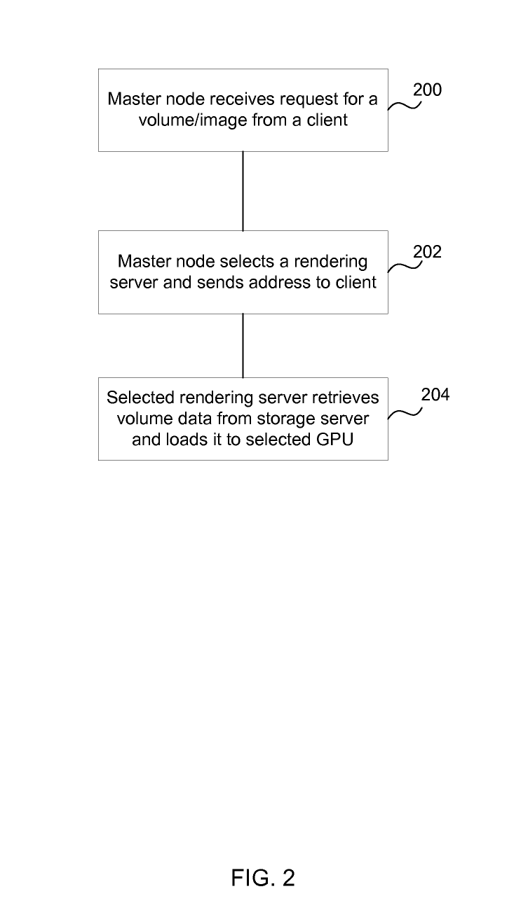

FIG. 2 is a flow diagram of rendering server selection. In an example a master rendering server node receives 200 a request for the processing of a volume or image from a client. The master node selects 202 a rendering server from a plurality of rendering servers (that are in its control or which are associated with it) and sends the address of the rendering server to the requesting client. The selection process may involve using load balancing techniques as described above to select a GPU and then selecting the rendering server to which that GPU is connected. In an example the client communicates only with the master node. In another example the client may then negotiate directly with the selected rendering server. The client may specify parameters in its request. A non-exhaustive list of parameters the client may specify is; desired frames, viewpoint, color transfer functions, opacity. The selected volume rendering server retrieves volume data from the storage server and loads 204 the data to the selected GPU. By performing load balancing among multiple processors (such as a cluster of rendering servers each having one or more GPUs) scalability is achieved that allows the data center to serve many different client requests simultaneously. Rather than needing to equip each client machine with the relevant hardware for rendering, it is possible to equip the rendering servers according to price and/or performance constraints without restricting the clients that may request rendered images. Also, by performing rendering remotely the system enables a surgeon at home (for example) with her netbook to see the same visualizations as a radiologist in his lab with a workstation. For example, the volume data is loaded as a 3-dimensional texture to the selected GPU attached to the rendering server.

Each rendering server has at least one GPU attached and each GPU may serve multiple clients. In an example, each rendering server is provided with a multi-threaded programming environment for controlling the GPU(s) attached to that rendering server. For example, this programming environment is arranged to provide good results where calls which use GPU resources occur in the same thread that allocates and frees those resources.

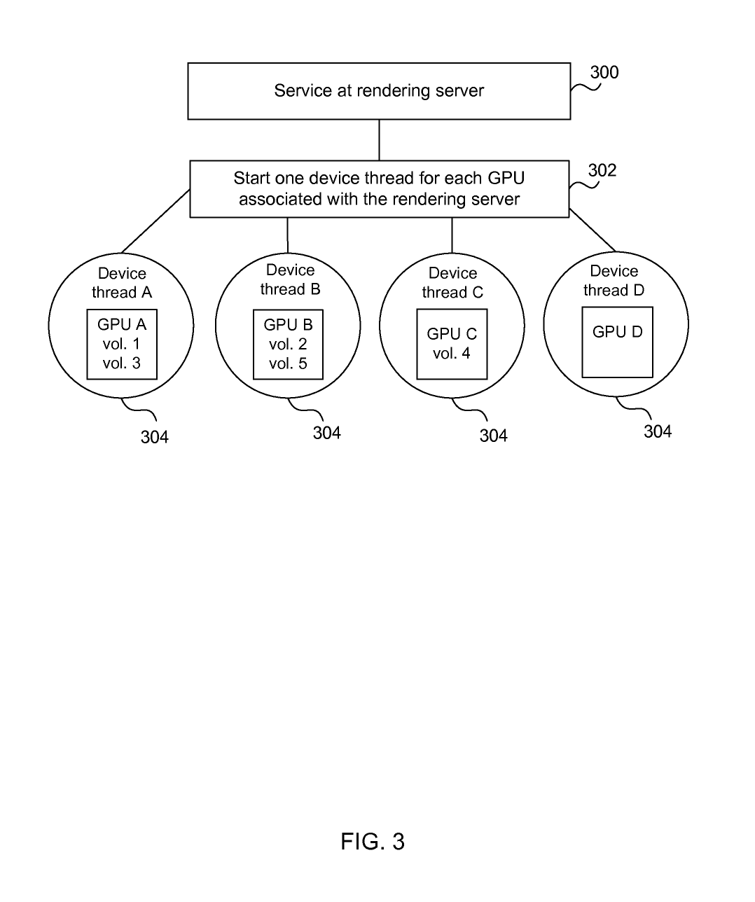

FIG. 3 is a flow diagram of device threads on a rendering server such as any of the rendering servers of FIG. 1. A service 300 is provided at each rendering server. The service may be a windows service or daemon for example. A plurality of calling threads associated with the service run on each rendering server. For each GPU associated with the rendering server a device thread is started 302. Each device thread 304 comprises a list of instructions to be carried out on any volumes cached on the GPU for that device thread.

On each rendering server a process is run which receives client requests, performs rendering and replies with data as appropriate. A plurality of threads can be associated with each process. In an example the threads can executed on multiple processors, on processors with multiple cores, or on a single multi-threading processor core. A non-limiting list of examples of multi-threading techniques is block multi-threading, interleaved multi-threading and simultaneous multi-threading. Each thread has access to shared system resources.

A device thread is started 302 for each GPU attached to the server. The device threads run at the CPU of the rendering server. As client requests arrive on the server simultaneously on different calling threads, it is determined which GPU can serve the request and the request data is serialized to the appropriate device thread associated with the GPU. Each time a device thread receives a render request it wakes up if necessary and processes the instructions in the queue. Each GPU may have a plurality of volumes for rendering stored in the cache. If a volume for rendering is not stored in the cache it is retrieved from the storage server 102.

By using separate device threads for each GPU controlled by a rendering server in conjunction with the calling threads as described, the benefit of being able to use a particular type of programming environment at the rendering server is achieved. This programming environment may be one which is arranged to provide good results where calls which use GPU resources occur in the same thread that allocates and frees those resources. For example, a calling thread is able to send instructions to multiple device threads in order to indirectly use any GPU resources. However, each device thread has calls which use only the resources of a single GPU.

In an example the rendering servers comprise a Compute Unified Device Architecture (CUDA®) environment for controlling the graphics processing units. For example, the graphics processing units may be nVidia® graphics processing units such as Tesla® S1070® which connects via cables to the PCIe bus of a host machine. However, this is an example only, any suitable type of graphics processing units may be used with any suitable programming environment at the rendering server.

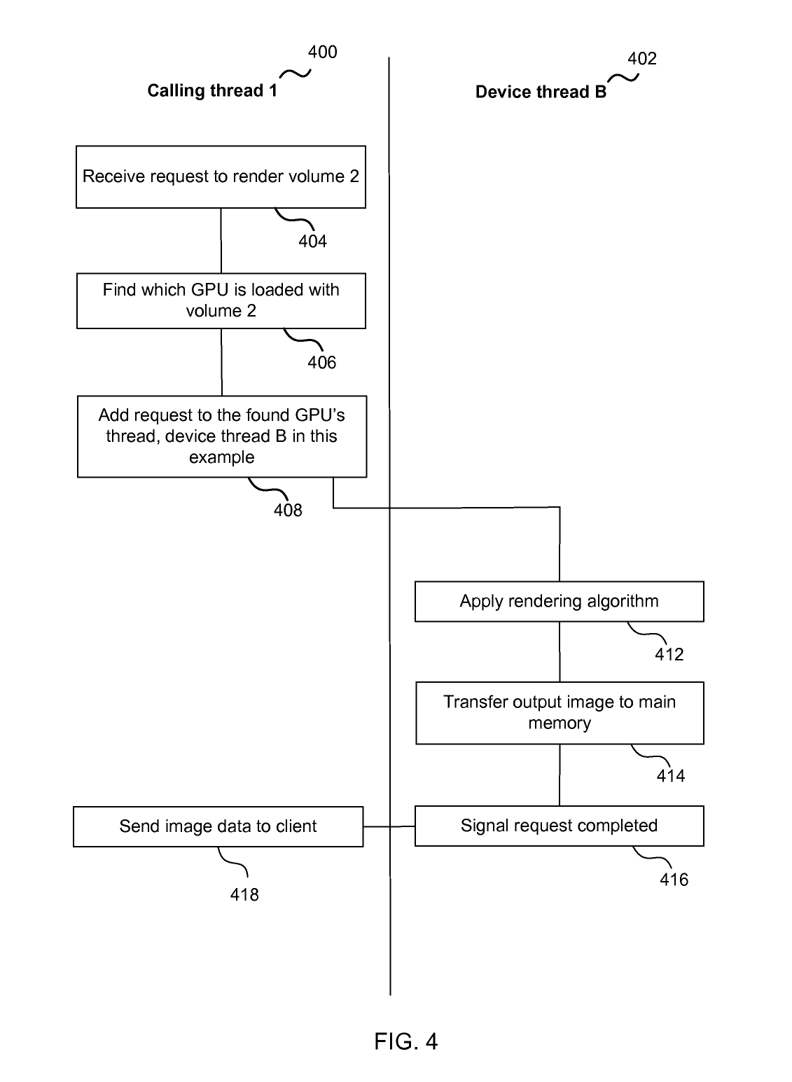

FIG. 4 is a flow diagram of interaction between a calling thread 400 and a device thread 402. The calling thread can be executed on a processor at a rendering server 102, 104 and the device thread is executed at the CPU of the rendering server. The calling thread receives 404 a request to render a volume (in this example volume 2). The calling thread then determines 406 which GPU is loaded with volume 2. A request is added 408 to the found GPU's device thread (in this example GPU B). The example of request to render a volume is intended as an example only. Any appropriate instruction may be received at the calling thread and then added to the device thread queue. A rendering algorithm is applied 412 by the device thread at the GPU. Any appropriate rendering algorithm may be used. The output, which comprises 2D image data, is transferred 414 from the GPU to main memory when the request is completed. A signal that the request is completed is sent 416 to the calling thread and image data is sent 418 to the client.

Each device thread 402 consists of a queue of instructions that the associated GPU is to carry out. A non exhaustive list of examples of instructions that the device thread can carry out is; retrieve data from storage, apply rendering algorithm, retrieve data from the cache, re-render data, transfer the rendered image to main memory.

There is only one device thread associated with each GPU. However, the device thread may contain many sets of instructions. The device threads can be in serial form. Instructions are sent to multiple device threads from a calling thread. If a volume has been previously stored in the cache of a GPU, instructions relating to that volume will continue to be sent to the device thread of the appropriate GPU. This ensures that memory and bandwidth resources are not used to retrieve data from the storage server 102 unnecessarily. If volume data has not previously stored in the cache of a GPU then the master rendering server 106 will select an appropriate rendering server using load balancing techniques as described above.

Each time the user requests a different image the volume is re-rendered. Storing volumes in the GPU cache reduces the time taken to execute repeat instructions from the user. A request received by the calling thread 400 may contain many parameters. A non exhaustive list of parameters that may be received is image width, image height, virtual camera position and color transfer functions. The parameters can be transferred with each request or stored in the cache 108. Each time a request for a different image, requiring re-rendering of the volume, is received at the calling thread, instructions to render the image are added to the device thread. The instructions are then executed in serial by the device thread.

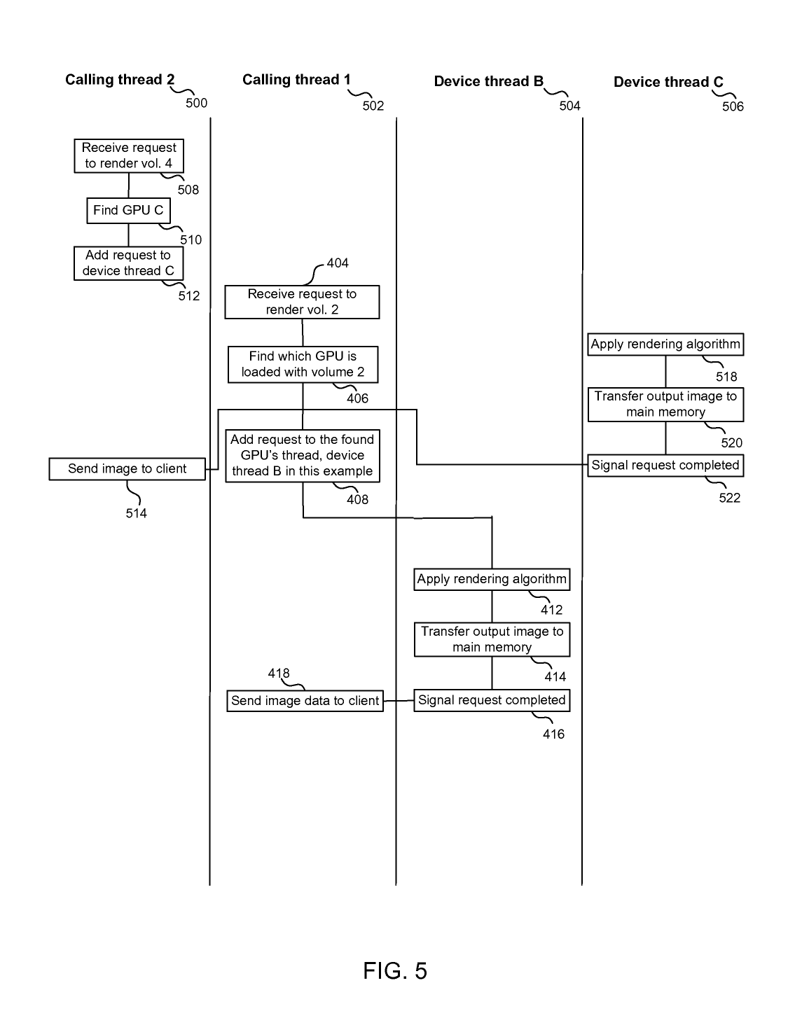

FIG. 5 is a flow diagram of interaction between a plurality of calling threads 500, 502 and a plurality of device threads 504. 506. In the example described herein there are two calling threads and two device threads but there may be any appropriate number of calling threads and the number of device threads is the same as the number of GPUs associated with each rendering server.

As described above, a calling thread receives 502 a request to render a volume (in this example volume 2). The calling thread then determines 406 which GPU is loaded with volume 2. A request is added 408 to the found GPU's device thread (in this example GPU B). A rendering algorithm is applied 412 and the output image is transferred 414 to main memory. A notification signal that the request is completed is sent 416 to the calling thread and image data is sent 418 to the client.

Calling thread 2 500 executes simultaneously to calling thread 1. Calling thread 2 receives a request 508 to render a volume (in this example volume 4). The calling thread determines that the volume (in this example volume 4) is associated 510 with a GPU (in this example GPU C). A request 512 is added 514 to the appropriate device thread's 506 queue to render volume 4. A rendering algorithm is applied 518 to volume 4 and the output image is transferred 520 to the main memory. A signal that the request has been completed 522 is returned to the calling thread 500.

In the examples described above with reference to FIG. 4 and FIG. 5 the volumes are already loaded to the cache of the GPU. However, the volumes may not have been previously retrieved. In an example where rendering requests are received from volumes that have not previously been rendered the volume would first be retrieved from storage. In an example an individual calling thread can be started for each request from a remote client. In another example requests from remote clients are distributed among a pool of calling threads.

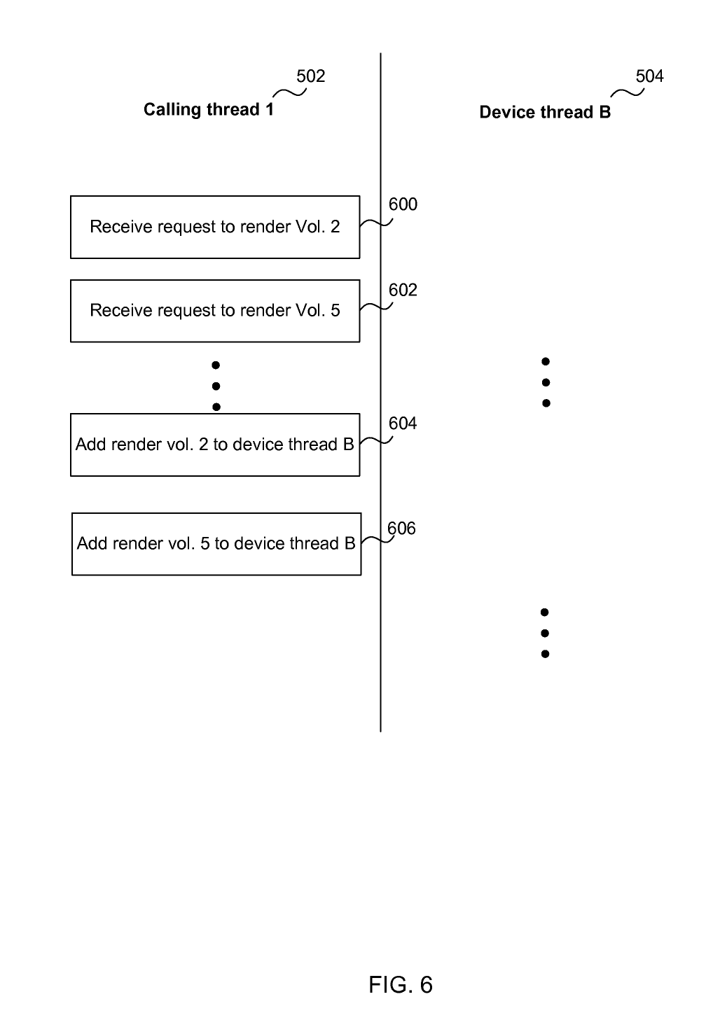

FIG. 6 is a flow diagram of multiple job processing. A calling thread 502 receives 600 a request for a volume (volume 2 in this example) to be rendered. Calling thread 502 then receives 602 a further request for a different volume (volume 5 in this example) to be rendered. The volumes are stored in the cache of the same GPU (GPU B in this example) and are therefore added 604, 606 to the device thread of GPU B in the order in which they are received.

In the example described herein the requests are received at the same calling thread. However, the requests could be received at different calling threads. Requests from a plurality of calling threads can be added to a device thread and are executed in the order in which they are received. In a further example the requests 600, 602 can be received at the same calling thread and distributed to a plurality of device threads. The distribution of requests from a plurality of calling threads to a plurality of device threads can be based on where volumes are cached. The distribution of requests can be based on load balancing techniques executed on a processor at the master rendering server.

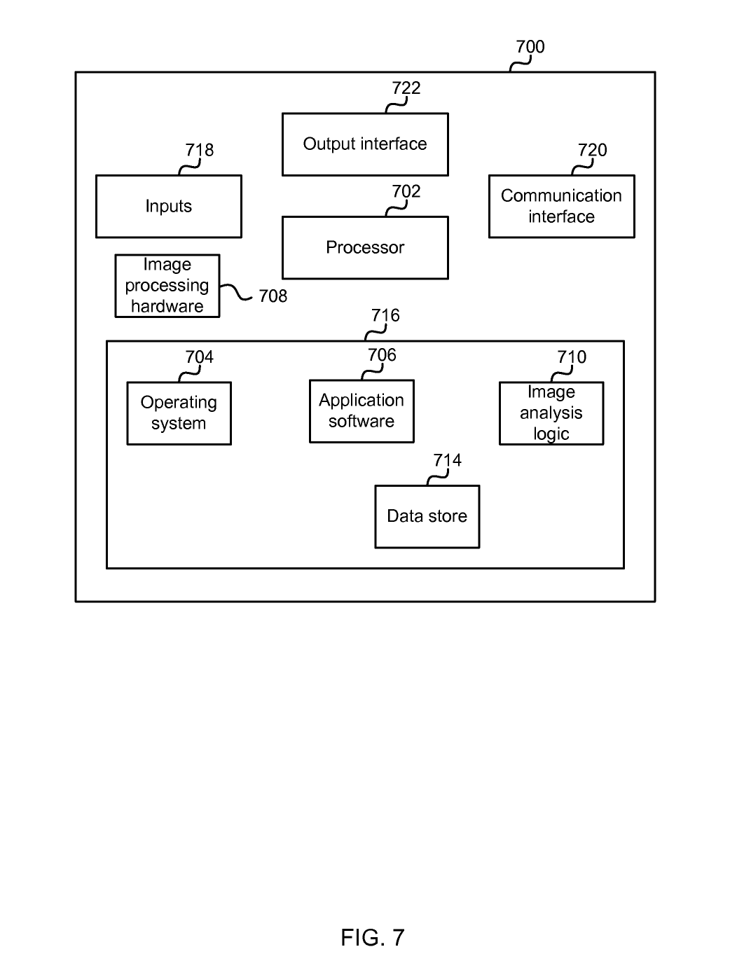

FIG. 7 illustrates various components of an exemplary computing-based device 700 which may be implemented as any form of a computing and/or electronic device, and in which embodiments of a volume rendering server may be implemented.

Computing-based device 700 comprises one or more processors 702 which may be microprocessors, controllers or any other suitable type of processors for processing computing executable instructions to control the operation of the device in order to execute volume rendering. Platform software comprising an operating system 704 or any other suitable platform software may be provided at the computing-based device to enable application software 706 to be executed on the device.

Image processing hardware 708 such as a graphics processing unit is also provided at the device 700. The image processing hardware may be one or more processing devices. Image analysis logic 710 may also be provided. The image analysis logic may be any form of appropriate rendering logic. In an example the rendering logic is a ray-casting engine. A data store 714 is provided in order to store 3 or higher dimensional data volumes.

The computing-based device 700 comprises one or more inputs 718 which are of any suitable type for receiving media content, Internet Protocol (IP) input, FTP input, TCP/IP input, HTTP input or any other appropriate input and including three or higher dimensional volume data. The device also comprises communication interface 720 to enable the device to communicate with other rendering servers, databases or other entities over a communications network.

The computer executable instructions may be provided using any computer-readable media, such as memory 716. The memory is of any suitable type such as random access memory (RAM), a disk storage device of any type such as a magnetic or optical storage device, a hard disk drive, or a CD, DVD or other disc drive. Flash memory, EPROM or EEPROM may also be used. Although the memory is shown within the computing-based device 700 it will be appreciated that the storage may be distributed or located remotely and accessed via a network or other communication link (e.g. using communication interface 720).

An output is also provided such as an audio and/or video output to a display system integral with or in communication with the computing-based device. An output interface 722 to a display system may provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method at a volume rendering system comprising:
arranging a volume rendering server to control a plurality of graphics processing units;
initiating, for each graphics processing unit a device thread;
executing at least one calling thread at the volume rendering server;
on the calling thread, receiving a request to render a volume, that volume being loaded into one of the graphics processing units;
on the calling thread, identifying which device thread is associated with the requested volume;
adding a render instruction for the volume to a queue of the identified device thread so that the volume is rendered to produce a two dimensional image.

2. A method as claimed in claim 1 which further comprises at the calling thread, sending an instruction to another device thread in order to use another of the graphics processing units.

3. A method as claimed in claim 1 wherein the calling thread is able to allocate and free resources of the graphics processing units by using the device threads.

4. A method as claimed in claim 1 which further comprises receiving at the calling thread a request to render another volume, that volume being loaded into the graphics processing unit; and adding a render instruction serially to a queue of the identified device thread.

5. A method as claimed in claim 1 which further comprises receiving an instruction from a master rendering server to retrieve a specified volume from a storage server and to load that volume into a graphics processing unit controlled by the volume rendering server.

6. A method as claimed in claim 1 wherein the volume is a medical volume data set.

7. A method as claimed in claim 1 which further comprises receiving a notification at the calling thread from the device thread indicating that the render instruction is complete and sending the two dimensional image to a client over a communications network.

8. A volume rendering server comprising:
a plurality of graphics processing units each having a device thread;
a processor arranged to execute at least one calling thread such that when a request to render a volume is received, that volume having been loaded into one of the graphics processing units, the calling thread identifies which device thread is associated with the requested volume and adds a render instruction for the volume to a queue of the identified device thread so that the volume is rendered to produce a two dimensional image.

9. A volume rendering server as claimed in claim 8 wherein the processor is arranged such that the calling thread, sends an instruction to another device thread in order to use another graphics processing unit.

10. A volume rendering server as claimed in claim 8 wherein the processor is arranged such that the calling thread is able to allocate and free resources of the graphics processing units by using the device threads.

11. A volume rendering server as claimed in claim 8 wherein the processor is arranged such that the calling thread is able to receive a request to render another volume, that volume being loaded into the graphics processing unit; and such that the calling thread is able to add a render instruction serially to a queue of the identified device thread.

12. A volume rendering server as claimed in claim 8 wherein the processor is arranged to receive an instruction from a master rendering server to retrieve a specified volume from a storage server and to load that volume into a graphics processing unit controlled by the volume rendering server.

13. A volume rendering server as claimed in claim 8 for rendering medical volume data.

14. A volume rendering server as claimed in claim 8 wherein the processor comprises a Compute Unified Device Architecture.

15. A volume rendering system comprising:
a database holding volumes being images of at least three dimensions;
a plurality of rendering servers each connected to the database;
each rendering server having at least one graphics processing unit connected to it, each of the graphics processing units having a dedicated device thread;
each of the rendering servers having a processor arranged to receive a request from a remote client to render one of the volumes, the processor being arranged to use a calling thread to instruct a device thread of one of the graphics processing units to render the volume.

16. A volume rendering system as claimed in claim 15 where at least one of the rendering servers is a master rendering server arranged to carryout load balancing between the rendering servers.

17. A volume rendering system as claimed in claim 15 wherein the remote client is a thin client.

18. A volume rendering system as claimed in claim 15 wherein the remote client is connected to the rendering server over a connection of lower bandwidth than the connection between the rendering server and the database.

19. A volume rendering system as claimed in claim 15 wherein each of the rendering servers comprises a Compute Unified Device Architecture.

20. A volume rendering system as claimed in claim 15 wherein the processor is arranged to identify which device thread is associated with the requested volume and to instruct the identified device thread.
